(19) United States
(12) Patent Application Publication
(10) Pub. No.: US 2018/0129983 A1
(43) Pub. Date: May 10, 2018

(54) REWARDS SYSTEM FOR REWARDING USERS FOR BOOKING LODGING

(71) Applicant: IBC Hotels LLC d/b/a IBC Hospitality Technologies, Phoenix, AZ (US)

(72) Inventor: PAMELA BARNHILL, PHOENIX, AZ (US)

(73) Assignee: IBC Hotels LLC d/b/a IBC Hospitality Technologies, Phoenix, AZ (US)

(21) Appl. No.: 15/803,066

(22) Filed: Nov. 3, 2017

Related U.S. Application Data
(60) Provisional application No. 62/417,520, filed on Nov. 4, 2016.

(51) Int. Cl. G06Q 10/02; G06Q 30/02; G06Q 30/06; G06Q 20/38; G06Q 20/04

(52) U.S. Cl. CPC G06Q 10/02; G06Q 30/0226; G06Q 30/0236; H04W 4/12; G06Q 30/06; G06Q 20/389; G06Q 20/0453; G06Q 30/0206

(57) ABSTRACT

Systems and methods are provided for rewarding users for reserving lodging. The method includes presenting, to a user, one or more options for booking lodging for a select duration of time at a lodging destination using an application on an electronic device. The method further includes receiving a notification from the lodging destination upon the user's arrival. The method further includes awarding the user with a predetermined number of rewards points if the user arrives at the lodging destination at an agreed upon time and updating a user profile if the user gains or loses any rewards points. The method additionally includes enabling the user to use one or more of the reward points toward booking one or more rooms in subsequent transactions using the application.

### CLAIM OF PRIORITY

This application claims priority to Provisional Patent Application No. 62/417,520, filed Nov. 4, 2016 and incorporated herein in its entirety.

### FIELD OF THE EMBODIMENTS

This invention relates to rewarding consumers for using digital applications and, in particular, to rewarding consumers for repeated use of a digital application to book lodging.

### BACKGROUND OF THE EMBODIMENTS

Long past are the days when the sole method of renting a room at a lodging destination was by calling the lodging destination and the speaking with a worker at that particular establishment. It is now possible to book a room without ever having to have any direct contact with the lodging destination.

With the dawn of websites and digital applications, consumers are able to search a wide variety of nearby hotels, motels, hostels, villas, private rentals and other lodging destinations, compare prices and reviews for each destination, and book your room directly from the website or digital application. However, with the vast number of websites and digital applications to choose from, there is little incentive to consistently rent from a single website or digital application. Also, with the ease of cancelling reservations through these websites and digital applications, there is little incentive to follow through with arriving at the reserved destination.

A method of booking rooms at lodging destinations and incentivizing consumers to both reuse the same method of booking the rooms and to follow through with their booked reservations is thus needed.

Examples of related art are described below:

U.S. Pat. No. 8,732,005 pertains to an automated consumer rewards/incentive program that accepts a registration of a consumer. The registration entitles the consumer to receive the benefits of the incentive program. To track the fulfillment of reward earning criteria established by member businesses, the registration includes information indicative of a credit card of the consumer. The system uses the credit card information to determine when member customers perform a transaction at a member business. When a member customer performs a transaction at a member business using the registered credit card, the system and method examines the credit card transactional information to determine if the consumer fulfilled the requirements of the incentive program for the member business. If the transactional information indicates that the consumer fulfilled the criteria of the rewards program of the member business, the consumer is rewarded in accordance with the benefits of the incentive program.

U.S. Pat. No. 8,838,472 pertains to a transaction is conducted at a merchant location using redeemed loyalty points maintained in a loyalty point account for a customer. The transactions are conducted using a mobile device at a POS terminal. In response to receiving a customer ID from the mobile device, a loyalty server provides the monetary value of loyalty points. The customer may use the mobile device to redeem those points and have the value transferred into a financial account. A payment processing system connected to the POS terminal completes the transaction using the financial account.

U.S. Pat. No. 9,324,091 pertains to methods, systems, software, computer readable non-transitory media, applications, devices, and the like for providing location based, mobile, user selected, time, location, and number limited or unlimited electronic coupon card selection of automatic location based reserve and redeem discounts on products or services with a profile picture, tag, motion enabled watermark, or other visual, 2D or mechanism for security purposes.

European Patent Application No. 2,369,546 pertains to a system and a method for providing at least one electronic coupon (EC) to a user of a mobile device for goods or services, wherein said electronic coupon (EC) is transmitted by an electronic coupon server to said mobile device depending on a current position of said mobile device and locations of point of sale (POS) of registered suppliers offering said goods and services, wherein the current position of the mobile device is detected by an application executed by a computation unit of the mobile device.

U.S. Patent Application No. 2004/0137886 pertains to a system for distributing electronic coupons includes plural wireless mobile terminals, such as cellular phones or personal digital assistants (PDAs), a customer profile database, and a server capable of accessing the customer profile database and communicating with the wireless mobile terminals over a wireless network. The database stores customer profiles for each of the wireless mobile terminals. The profiles include customer data, such as customer preferences and the current location of each wireless terminal. The server selectively transfers one or more electronic coupons to at least one of the wireless mobile terminals based on a comparison between the customer profiles and seller filtering criteria. A seller interface permits sellers to enter the seller filtering criteria. The filtering criteria can include the physical location of the seller so that coupons are sent only to those wireless terminals at or near the seller's location.

U.S. Patent Application No. 2009/0287558 pertains to one or more aspects of electronic coupon tracking, wherein a record of an electronic coupon that has been distributed to a user is maintained. An indication that the electronic coupon has been redeemed at a retailer via a mobile device is received, and redemption of the electronic is recorded. Additionally, an indication can be received that the electronic coupon has been redeemed by the user. In response to receipt of this indication, a rewards account corresponding to the user is credited with one or more points.

U.S. Patent Application No. 2011/0106613 pertains to electronic coupon distribution, collection, and utilization systems and methods. An exemplary method includes maintaining coupon data representative of at least one electronic coupon collected by a consumer, the coupon data accessible by a mobile computing device associated with the consumer, detecting an occurrence of a predetermined trigger event related to the at least one electronic coupon, and providing, in response to the predetermined trigger event, a message for presentation to the consumer via the mobile computing device associated with the consumer, the message configured to direct the consumer to a physical location of a product associated with the at least one electronic coupon. Corresponding systems and methods are also disclosed.

U.S. Patent Application No. 2015/0073888 pertains to a system and method that allows a consumer to purchase goods and services from merchants and redeem offers made by a merchant with a digital transaction on a smart phone. The merchant receives and enters the consumer's telephone number into an application. The consumer's telephone number is sent to a server, which checks for electronic coupons and loyalty points. Accounting for the value of any coupon/accumulated loyalty points, the merchant enters the payment amount into the application which in turn sends it back to the server. The server then sends the payment amount, any coupon details and the merchant's name to the consumer's phone. The consumer can choose to accept or decline the sale with or without using the coupon/loyalty points. A PIN number confirms the sale, which transmits to the server and then to the merchant. A digital sales receipt is sent to the merchant and consumer.

It is noted that none of the art described above addresses all of the issues that the present invention does.

### SUMMARY OF THE EMBODIMENTS

According to an embodiment of the present invention, a method is provided for rewarding users for reserving lodging. The method includes: presenting to a user, using a processor, one or more options for booking lodging; enabling the user to book one or more rooms, from the one or more options, for a select duration of time at a lodging destination using an application on an electronic device; receiving, by the processor, notification from the lodging destination upon the user's arrival that the user has arrived at the lodging destination; if the user arrives at the lodging destination at an agreed upon time, awarding the user with a predetermined number of rewards points; if the user gains or loses any rewards points, updating a profile of the user, wherein the updating includes altering a number of reward points listed in the profile of the user; and enabling the user to use one or more of the reward points toward booking one or more rooms in subsequent transactions using the application.

It is an object of the present invention to provide for the method for rewarding users for reserving lodging, wherein the enabling further includes enabling the user to use the one or more of the reward points to create one or more coupon codes, wherein each of the one or more coupon codes can be used to enable a discount on one or more future lodging bookings.

It is an object of the present invention to provide for the method for rewarding users for reserving lodging, wherein the discount is equivalent to a mean price paid per room per night for a predetermined number of previous room bookings.

It is an object of the present invention to provide for the method for rewarding users for reserving lodging, wherein one or more steps of the method are implemented using an application on a mobile electronic device.

It is an object of the present invention to provide for the method for rewarding users for reserving lodging, wherein presenting to the user the one or more options for booking lodging further comprises: presenting to the user, using a graphical user interface, a list of lodging search options; enabling the user to select one or more search criteria from the list of lodging search options; receiving, using the processor, the one or more search criteria; and determining the one or more options for booking lodging based on the one or more search criteria.

It is an object of the present invention to provide for the method for rewarding users for reserving lodging, wherein a predetermined amount of reward points qualifies the user to a free night at a lodging location up to a predetermined monetary amount.

It is an object of the present invention to provide for the method for rewarding users for reserving lodging, further comprising saving, in a memory, all transactions made by the user using the application.

It is an object of the present invention to provide for the method for rewarding users for reserving lodging, further comprising saving, in a memory, all rooms that are booked using the application, and which days for which each of the rooms were booked, for each lodging destination.

It is an object of the present invention to provide for the method for rewarding users for reserving lodging, further comprising notifying a lodging destination when a room at that lodging destination has been booked using the application.

It is an object of the present invention to provide for the method for rewarding users for reserving lodging, further comprising enabling the user to pre-pay for one or more rooms booked using the application prior to arriving at the lodging destination where the one or more rooms are booked and applying a credit to the profile of the user for any amount pre-paid by the user.

### BRIEF DESCRIPTION OF THE DRAWINGS

FIG. 1 shows a flowchart of a method for rewarding users for reserving lodging, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

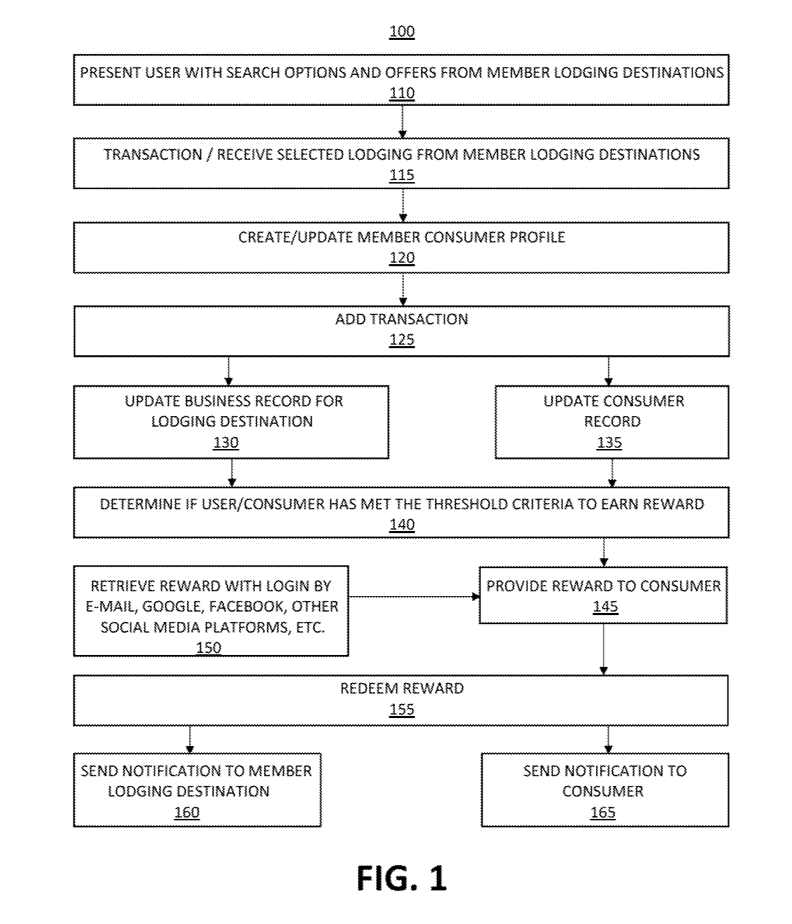

Referring now to FIG. 1, a flowchart of a method 100 for rewarding users for reserving lodging is illustratively depicted, in accordance with an embodiment of the present invention.

At step 110, a first user is presented with a listing of various lodging destinations such as, e.g., hotels, motels, resorts, hostels, etc. According to an embodiment, the user is presented with the listing on a graphical user interface, wherein the user is able to interact with a website and/or application for a system that is displayed on the graphical user interface.

According to an embodiment, the website and/or application presents the user with a search tool. This search tool enables the user to input various criteria, such as, e.g., a price range, the dates on which the user desires to stay at a lodging destination, the rating of the lodging destinations, the area in which the user would like to stay, etc.

According to an embodiment, the graphical user interface is on a mobile electronic device such as, e.g., a cell phone, a computer tablet, a laptop computer, etc.

Once the user inputs the lodging destination criteria, the application and/or website returns results based on the criteria, offering rooms at lodging destinations. According to an embodiment, the application and/or website only offers rooms at lodging destinations that are members of the business with which the search was made.

At step 115, the user selects one or more lodging destinations and books a reservation at the lodging destination. According to an embodiment, the user pays the full amount to be paid for the room at the time of the reservation. According to another embodiment, the user pays a down payment to reserve the reservation.

At step 120, a consumer profile for the user is either created (for new consumers) or updated (for returning users). According to an embodiment, the consumer profile includes information about the user such as, e.g., name, age, address, payment information, number of rooms booked using the application and/or website, amount of rewards points earned and/or used, etc.

At step 125, the transaction the user made when reserving one or more rooms at the lodging destination is added to the system. This includes, at step 130, updating a record for the lodging destination indicating the reservation made, and, at step 135, updating a consumer record for the user. According to an embodiment, the user's reservation history on the user's consumer profile is updated to include the information regarding the reservation.

According to an embodiment, the system saves, in a memory, all rooms that are booked using the application, and which days for which each of the rooms were booked, for each lodging destination.

According to another embodiment, the system notifies the user when the user has successfully booked a room using the application.

All transactions made using the system are maintained. For example, if there is any monetary amount that the business running the system owes the lodging destination, a credit is listed in the system of the amount owed to the lodging destination. If the lodging destination owes the business running the business any monetary amount, a debit is listed in the system of the amount owed from the lodging destination.

According to an embodiment, the system allows the user to pre-pay for one or more rooms booked using the application prior to arriving at the lodging destination where the one or more rooms are booked, and applies a credit to the profile of the user for any amount pre-paid by the user. According to an embodiment, the system sends the user a receipt of all money transfers made during a transaction on the application.

According to an embodiment, the business running the system receives a predetermined commission from lodging destinations for any rooms booked using the system. For any reservations, transaction entries are automatically added based on the reservation type and commission percentage. In case the reservation is canceled, the system will revert the earlier transaction for that booking.

According to an embodiment, all automated transactions receive a proper description in the system explaining the purpose of that transaction. Additionally, according to an embodiment, a history of all transactions and activities are maintained in the system.

According to an embodiment, apart from any commission transactions for a reservation, the system also adds an automatic transaction for any lodging destination that has opted for an extended loyalty program with the business running the system.

At step 140, the system for the application and/or website determines if the user has met the criteria for earning rewards points.

According to an embodiment, the criteria for earning rewards points includes, e.g., the number of rooms booked by the user using the system, any promotional codes used by the user during the reservation process, etc.

According to an embodiment, the user does not receive any rewards points until the user arrives at the reserved lodging destination. According to an embodiment, the user is not listed as having arrived at the lodging destination until the lodging destination send a notification to the system confirming the user's arrival.

According to an embodiment, the number of rewards points earned is predefined by the system. According to an embodiment, the number of points earned by the user is dependent upon any promotional codes the user used when making the reservation. For example, a code may indicate that the user will receive 1 point for every room booked using the system that the user successfully arrives at.

At step 145, once the user has met the criteria to receive rewards points, the user's consumer profile is updated with the current number of rewards points after the addition of the earned rewards points.

At step 150, upon receiving rewards points, the user is able to retrieve the points using an internet-based platform such as, e.g., e-mail, Google, Facebook, other social media platforms, etc. It is noted that any adequate form of rewards points retrieval may be used, while maintaining the spirit of the present invention.

At step 155, the user redeems rewards using any rewards points the user has stored in the user's consumer profile. Once any rewards points are used, the user's consumer profile is again updated to indicate the current amount of rewards points the user may use.

According to an embodiment, the redeemable rewards are predetermined by the system. For example, the system may indicate that 12 points can be traded in for one free night at a room. According to an embodiment, users can trade rewards points for a coupon code, which can then be used during the user's next reservation booked using the system. These rewards provide an incentive for users to follow through with arriving at the reserved destinations, which is an improvement upon the existing technologies.

According to an embodiment, any discount redeemable from the coupon code is calculated using the transaction history of the user. For example, the discount amount may be equivalent to the mean price paid per room per night for a predetermined number of previous room bookings by the user, such as, e.g., the mean price of the user's last 12 room bookings.

At step 160, if the user books a room using any redeemed rewards, the lodging destination at which those rewards are used is notified via, e.g., e-mail, text, etc.

At step 165, if the user books a room using any redeemed rewards, the user receives a confirmation notification via, e.g., e-mail, text, etc.

While processing transactions, the system calculates the total credit and/or debit balances for all unprocessed transactions. If the final balance comes in credit, the system creates a payment slip. If the final balance comes in debit, the system creates an invoice. According to an embodiment, both the payment slips and the invoices are registered in the system, which keeps track of all transactions considered for that invoice/payment slip processing period. According to an embodiment, both payment slips and invoices are reported to the appropriate lodging destinations and marked as settled upon the settling of any credit and/or debit amounts.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present ivention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA) and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for rewarding users for reserving lodging, comprising:
presenting to a user, using a processor, one or more options for booking lodging;
enabling the user to book one or more rooms, from the one or more options, for a select duration of time at a lodging destination using an application on an electronic device;
receiving, by the processor, notification from the lodging destination upon the user's arrival that the user has arrived at the lodging destination;
if the user arrives at the lodging destination at an agreed upon time, awarding the user with a predetermined number of rewards points;
if the user gains or loses any rewards points, updating a profile of the user, wherein the updating includes altering a number of reward points listed in the profile of the user; and
enabling the user to use one or more of the reward points toward booking one or more rooms in subsequent transactions using the application.

2. The method as recited in claim 1, wherein the enabling further includes enabling the user to use the one or more of the reward points to create one or more coupon codes,
wherein each of the one or more coupon codes can be used to enable a discount on one or more future lodging bookings.

3. The method as recited in claim 2, wherein the one or more coupon codes are inputted by the user using a mobile electronic device.

4. The method as recited in claim 2, wherein the discount is equivalent to a mean price paid per room per night for a predetermined number of previous room bookings.

5. The method as recited in claim 4, wherein the predetermined number of previous room bookings is 12.

6. The method as recited in claim 1, wherein one or more steps of the method are implemented using an application on a mobile electronic device.

7. The method as recited in claim 6, wherein the application is configured specifically to perform one or more of the steps of the method.

8. The method as recited in claim 1, wherein presenting to the user the one or more options for booking lodging further comprises:
presenting to the user, using a graphical user interface, a list of lodging search options;
enabling the user to select one or more search criteria from the list of lodging search options;
receiving, using the processor, the one or more search criteria; and
determining the one or more options for booking lodging based on the one or more search criteria.

9. The method as recited in claim 1, wherein a predetermined amount of reward points qualifies the user to a free night at a lodging location up to a predetermined monetary amount.

10. The method as recited in claim 9, wherein the predetermined monetary amount is based on the purchase price of one or more of the user's previous booked rooms at one or more lodging destinations.

11. The method as recited in claim 1, further comprising saving, in a memory, all transactions made by the user using the application.

12. The method as recited in claim 11, further comprising notifying the user when the user has successfully booked a room using the application.

13. The method as recited in claim 1, further comprising saving, in a memory, all rooms that are booked using the application, and which days for which each of the rooms were booked, for each lodging destination.

14. The method as recited in claim 13, wherein a lodging destination receives a predetermined percentage of income generated from rooms booked using the application at that lodging destination.

15. The method as recited in claim 13, further comprising notifying a lodging destination when a room at that lodging destination has been booked using the application.

16. The method as recited in claim 1, further comprising, if the user is granted any rewards points, notifying the user of the rewards points the used has been granted.

17. The method as recited in claim 1, further comprising, if the number of rewards points listed in the profile of the user has decreased, notifying the user of the user's current balance of rewards points.

18. The method as recited in claim 1, further comprising:
enabling the user to pre-pay for one or more rooms booked using the application prior to arriving at the lodging destination where the one or more rooms are booked; and
applying a credit to the profile of the user for any amount pre-paid by the user.

19. The method as recited in claim 18, further comprising sending the user a receipt of all money transfers made during a transaction on the application.

20. The method as recited in claim 1, further comprising, upon the user booking one or more rooms, updating the profile of the user to include a debit of any monetary amount owed toward the room booking.
